(19) United States
(12) Patent Application Publication
(10) Pub. No.: US 2017/0276443 A1
(43) Pub. Date: Sep. 28, 2017

(54) ROTATIONAL SPRAYER CLEANING DEVICE FOR AN AIR CONDITIONER CONDENSING UNIT AND METHOD

(71) Applicant: Albert William Bode, III, Edmond, OK (US)

(72) Inventor: Albert William Bode, III, Edmond, OK (US)

(21) Appl. No.: 15/076,877

(22) Filed: Mar. 22, 2016

(51) Int. Cl. F28G 3/16; F25B 47/00; F24F 1/46; B05B 3/10

(52) U.S. Cl. CPC F28G 3/166; B05B 3/1007; F25B 47/00; F24F 1/46; F24F 2221/225

(57) ABSTRACT

An improved cleaning device for an air conditioning condensing unit having a housing with a sprayer cleaning device therein which includes a rotatably disposed spray nozzle connected to a spray nozzle conduit which operably communicably connects to a hose coupling connection outside the housing, wherein the spray nozzle conduit rotates about a rotational axis. A method of cleaning the air conditioning condensing unit employs the sprayer cleaning device.

### FIELD OF INVENTION

The instant invention relates to cleaning air conditioner condensers. More particularly, the invention to a rotationally mounted sprayer within an air conditioning condensing unit.

### PRIOR ART

There exist numerous prior cleaning devices and methods for cleaning air conditioner condensers. For example, one system is directed to a reversible fan system to push air flow in an opposite direction on demand in order to flush the condenser unit. Other Systems employ different techniques for washing the condenser unit. These types of techniques employee stationary components and a pump and are relatively expensive.

There is a need to provide a simpler in less expensive cleaning device for air conditioner condenser units. The instant invention overcomes the deficiencies in the art buy so providing and improved cleaning device for air conditioner condenser units.

### SUMMARY OF THE INVENTION

It is an object to improve air conditioner condensing units.

It is a further object to ease cleaning and maintenance of an air conditioner condensing unit.

Another object of the invention is to provide an improved sprayer cleaning device within an air conditioning condensing unit.

Accordingly, one embodiment is directed to and improved cleaning device for an air conditioning condensing unit. Another embodiment is directed to an improved air-conditioner condensing unit having a sprayer cleaning device of the invention operably dispose therein. Yet another embodiment is directed to a method cleaning an air conditioning condensing unit employing the invention.

The sprayer cleaning device includes within a housing of the air conditioning condensing unit a rotatably dispose spray nozzle operably connected to a conduit which operably communicably connects outside the air conditioning condenser housing to a hose coupling connection. The device can include one or more bearing mechanisms which rotatably sealably receive one or more end of a spray nozzle conduit. It is envisioned that the spray nozzle conduit can have one end rotatably disposed in a bearing surface of one internal part of the housing and another end disposed in a bearing surface of another internal part of the housing. The spray nozzle conduit can preferably include a plurality of spray nozzles oriented radially outward. It is contemplated that the spray nozzles can be preferably positioned in a common direction along the length of the spray nozzle conduit.

A preferred design element, the spray nozzle conduit can include a U-shaped portion having a longitudinal section which contains the spray nozzles such that the spray nozzles are radially offset from a rotational axis of the spray nozzle conduit. It is conceived that one or more the spray nozzles maybe offset directionally to provide a rotational drive components. For example, one or more spray nozzle can be directed at approximately 90° tangent to the rotation circumference of the longitudinal section.

The method of the invention includes the use of the rotational spray nozzle device in an air conditioner condensing unit having a hose connector connected thereto and extending outside of the unit, connecting a hose to the hose connector and running water through the hose and out the spray nozzle device to cause water to be emitted in a 360° manner within the condensing unit.

### BRIEF DESCRIPTION OF DRAWING

FIG. 1 is a schematic view with a cutaway revealing and illustrating a rotational sprayer cleaning device for an air conditioner condenser and method of use.

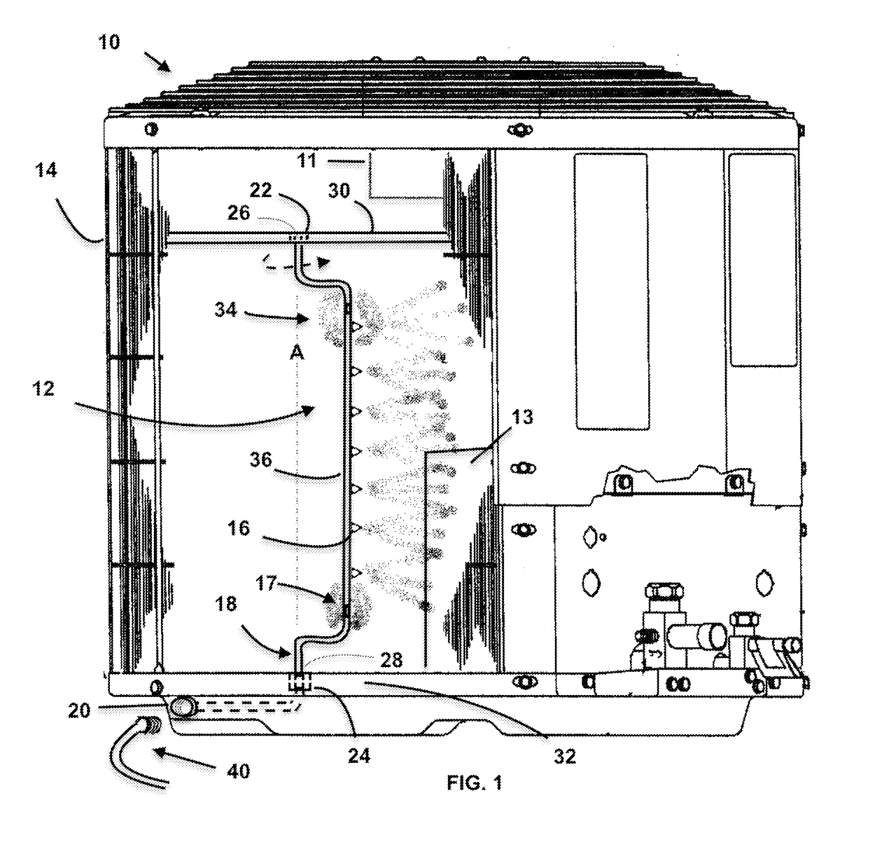

### DETAILED DESCRIPTION OF PREFERRED EMBODIMENT

Referring now to the drawing, the rotational sprayer cleaning device for an air conditioner condenser unit 10 is generally represented by the number 12. The air conditioner condenser unit 10 includes a fan and motor unit 11 and compressor 13 operatively disposed in a housing 14. The sprayer cleaning device 12 is operably disposed within the housing 14 of the air conditioning condensing unit 10 and includes rotatably disposed spray nozzles 16 operably connected to a spray nozzle conduit 18 which operably communicably connects to outside the air conditioning condenser housing 14 by way of a hose coupling connection 20.

The sprayer cleaning device 12 can preferably include bearing surfaces 22 and 24 which rotatably sealably receive ends 26 and 28, respectively, of a spray nozzle conduit 18. It is envisioned that the spray nozzle conduit 18 can have end 26 rotatably disposed in a bearing surface 22 of one internal part, cross member 30, of the housing 14 and end 28 disposed in a bearing surface 24 of another internal part, base 32, of the housing 14. The spray nozzle conduit 18 can preferably include a plurality of spray nozzles 16 oriented radially outward with respect to axis A. An conduit 21 is operably disposed in the housing 14 interconnecting hose coupling 20 and bearing surface 24. t is contemplated that the spray nozzles 16 can be preferably positioned in a common direction along the length of the spray nozzle conduit 18.

In a preferred design element, the spray nozzle conduit 18 can include a U-shaped portion 34 having a longitudinal section 36 which contains the spray nozzles 16, 17, such that the spray nozzles 16, 17 are radially offset from a rotational axis A. It is conceived that one or more the spray nozzles 17 maybe offset directionally to provide a rotational drive components. For example, one or more spray nozzle 17 can be directed at approximately 90° tangent to the rotation circumference of the longitudinal section 36.

The method of the invention includes the use of the rotational spray nozzle device 12 in an air conditioner condensing unit 10 having a hose connector 20 connected thereto and extending outside of the air conditioner condensing unit 10. The method further includes connecting a hose 40 to the hose connector and running water through the hose and out the spray nozzle device to cause water to be emitted in a 360° manner within the condensing unit.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention as claimed.

What is claimed is:

1. An improved cleaning device for an air conditioning condensing unit having a housing, which includes:
a sprayer cleaning device includes within the housing of the air conditioning condensing unit which includes at least one rotatably disposed spray nozzle connected to a spray nozzle conduit which operably communicably connects to a hose coupling connection outside the housing, wherein said spray nozzle conduit rotates about a rotational axis.

2. The improved cleaning device of claim 1, including at least one bearing surface which rotatably sealably receives an end of said spray nozzle conduit.

3. The improved cleaning device of claim 1, wherein said spray nozzle conduit has a first end rotatably disposed in a bearing surface of a first internal part of the housing and a second end disposed in a bearing surface of second internal part of the housing.

4. The improved cleaning device of claim 1, wherein said spray nozzle conduit includes a plurality of spray nozzles oriented radially outward with respect to said axis.

5. The improved cleaning device of claim 4, wherein said spray nozzles are positioned in a common direction along a length of said spray nozzle conduit.

6. The improved cleaning device of claim 1, wherein said spray nozzle conduit includes a U-shaped portion having a longitudinal section which contains said spray nozzle such that said spray nozzle is radially offset from said rotational axis of said spray nozzle conduit.

7. The improved cleaning device of claim 6, wherein said spray nozzles are offset directionally to provide a rotational drive components.

8. The improved cleaning device of claim 7, wherein at least one spray nozzle is directed at approximately 90° tangent to a rotation circumference of said longitudinal section.

9. An improved air-conditioner condensing unit, which includes:
a housing;
a fan and motor unit operatively disposed in said housing;
a compressor operatively disposed in said housing; and
a sprayer cleaning device operatively disposed in said housing which includes at least one rotatably disposed spray nozzle connected to a spray nozzle conduit which operably communicably connects to a hose coupling connection outside said housing, wherein said spray nozzle conduit rotates about a rotational axis.

10. The improved air-conditioner condensing unit of claim 9, including at least one bearing surface which rotatably sealably receives an end of said spray nozzle conduit.

11. The improved air-conditioner condensing unit of claim 9, wherein said spray nozzle conduit has a first end rotatably disposed in a bearing surface of a first internal part of said housing and a second end disposed in a bearing surface of second internal part of said housing.

12. The improved air-conditioner condensing unit of claim 9, wherein said spray nozzle conduit includes a plurality of spray nozzles oriented radially outward with respect to said axis.

13. The improved air-conditioner condensing unit of claim 12, wherein said spray nozzles are positioned in a common direction along a length of said spray nozzle conduit.

14. The improved air-conditioner condensing unit of claim 9, wherein said spray nozzle conduit includes a U-shaped portion having a longitudinal section and which contains a plurality spray nozzles such that said spray nozzles are radially offset from said rotational axis of said spray nozzle conduit.

15. The improved air-conditioner condensing unit of claim 14, wherein said spray nozzles are offset directionally to provide a rotational drive components.

16. The improved cleaning device of claim 15, wherein at least one spray nozzle is directed at approximately 90° tangent to a rotation circumference of said longitudinal section.

17. A method cleaning an air conditioning condensing unit, which includes:
employing within the air conditioning condensing unit a sprayer cleaning device which includes at least one rotatably disposed spray nozzle connected to a spray nozzle conduit which operably communicably connects to a hose coupling connection outside said air conditioning condensing unit, wherein said spray nozzle conduit rotates about a rotational axis;
connecting water supply hose to said hose coupling connection; and
causing water to flow through said house to and out said spray nozzle.
